(19) United States
(12) Patent Application Publication
(10) Pub. No.: US 2004/0107736 A1
(43) Pub. Date: Jun. 10, 2004

(54) Pure upflow furnace

(75) Inventors: Olivier Schuepbach, Irigny (FR); Allan Barnes, Aiken, SC (US); Steve Lebris, Argentevil (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 10/314,137

(22) Filed: Dec. 9, 2002

(51) Int. Cl. C03B 37/029

(52) U.S. Cl. 65/435; 65/537; 65/532; 65/430

(57) ABSTRACT

A furnace is provided. The furnace includes a chamber for heating a portion of a preform to draw a fiber. The chamber has a melt region for melting the preform, and at least one port disposed proximate to the melt region. A purge gas supply is provided for supplying a purge gas into the chamber. The purge gas moves vapor products away from the fiber and exits the chamber through the at least one port.

### BACKGROUND OF THE INVENTION

1. Field of the Invention

The present invention is directed to an apparatus and method for drawing optical fibers. More specifically, the invention is directed to an apparatus and method for reducing fiber breakage during draw of optical fiber from a preform.

2. Description of Related Art

Optical fibers are widely used in telecommunications. Optical fibers are generally drawn from a silica preform by heating an end of the preform to a temperature sufficient to melt the silica, then drawing a thin strand of molten material from the heated preform. Continuous drawing of the molten material, followed by cooling of the molten material, results in creation of an optical fiber. During the fiber draw process, vapor products such as silicon dioxide and silicon carbide are present near the preform. These vapor products correspond to the equilibrium vapor pressure of compounds above their respective solid phase, and their subsequent products from reacting with their environment. Particles often condense from these vapor products as the gasses cool. These particles can then come in contact with the optical fiber, potentially damaging or breaking the optical fiber.

Currently, there is no feasible apparatus and method for preventing the particles from touching the optical fiber. Accordingly, a need exists for an apparatus and method for preventing particles from coming in contact with the optical fiber during the draw process.

### ASPECT OF THE INVENTION

It is an object of the invention to reduce breakage of optical fibers during fiber draw.

In a first aspect of the present invention, a furnace is provided. The furnace includes a chamber for heating a portion of a preform to draw a fiber. The chamber has a melt region for melting the preform, and at least one port disposed proximate to the melt region. The furnace also includes a purge gas supply for supplying a purge gas into the chamber. The purge gas moves vapor products away from the fiber and exits the chamber through at least one port.

In a second aspect of the present invention, a fiber forming device is provided. The fiber forming device includes heat generating means for melting a portion of a preform, and gas supply means. The gas supply means supplies a purge gas for purging vapor products from the heat generating means. The exhausting means exhausts the purge gas and the vapor products out of the heat generating means before particles condense from the vapor products.

In yet another aspect of the present invention, a method of drawing fiber is provided. The method includes the steps of providing a chamber having a preform opening for accepting a preform and a melt region for melting the preform, and heating the preform in the melt region of the chamber until a portion of the preform is molten and vapor products are present. The method further includes the step of exhausting the vapor products from the chamber before particles condense from the vapor products.

These and other objects, aspects, features and advantages of the present invention will become apparent from the following detailed description of the preferred embodiment taken in conjunction with the accompanying drawings.

### BRIEF DESCRIPTION OF THE DRAWINGS

FIG. 1 illustrates a schematic view of a fiber draw apparatus according to the present invention.

FIG. 2 illustrates a draw furnace in accordance with a preferred embodiment of the present invention.

### DETAILED DESCRIPTION OF THE INVENTION

As explained below in detail, a preferred embodiment of the present invention provides an apparatus and method for exhausting gas during the fiber draw process. Of course, the present invention should not be limited to solely such features. These and other features of the preferred embodiment of the present invention are described below with reference to the drawings.

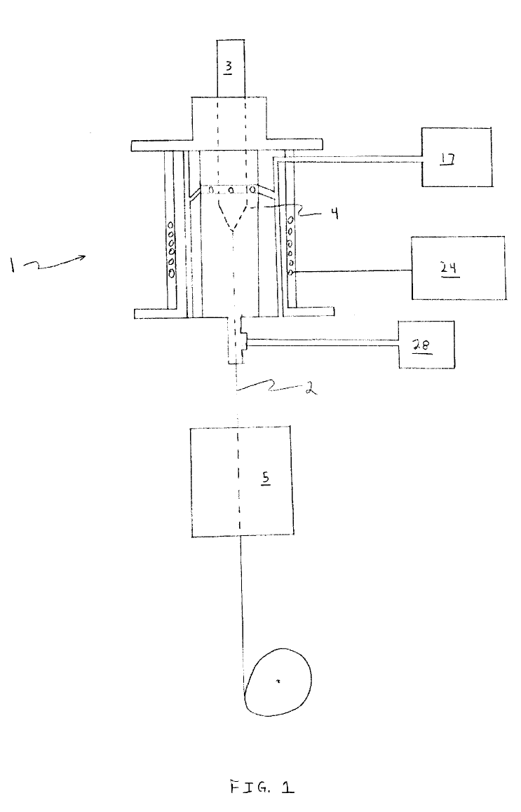

FIG. 1 illustrates a preform draw furnace 1 for drawing an optical fiber 2 from a preform 3. The preform is primarily silica glass having dopants such as fluorine and germanium to provide predetermined optical properties. Of course, the preform 3 may be made of materials other than silica, and may include dopants other than those listed above. The preform 3 is heated in a chamber 4 until a lower portion of the preform 3 is molten and the optical fiber 2 may be continuously drawn from the preform 3. The drawn optical fiber 2 passes through a fiber coating device 5 in which a coating is applied to the optical fiber 2. After being coated, the optical fiber 2 is wound onto a spool or other storage device. These and other features of the draw furnace 1 are described below in detail.

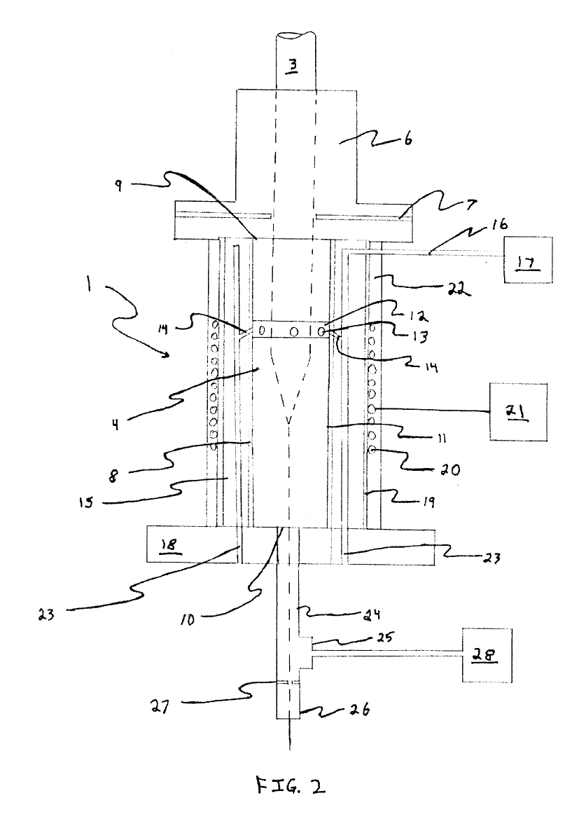

As shown in FIG. 2, the preform 3 may be positioned in the draw furnace 1 such that the chamber 4 of the draw furnace 1 heats the lower portion of the preform 3 from which the optical fiber 2 is drawn. The chamber 4, and other areas of the draw furnace 1, includes carbon and other materials maintained at a relatively high temperature. The carbon and other materials would undesirably burn if brought into contact with oxygen. To prevent such burning, the draw furnace 1 includes a first seal 6 through which the preform 3 is lowered. The first seal 6 prevents air from entering the interior of the draw furnace 1 thereby preventing combustion within the draw furnace 1. In a preferred embodiment the first seal 6 includes the combination of a mechanical seal and a gas pressure differential for preventing air from entering the furnace. Specifically, the mechanical seal includes features such as carbon paper that physically contact the preform 3 to create a physical barrier around the preform 3 as the preform 3 is lowered into the draw furnace 1. Further, a positive pressure of an inert gas is maintained within the first seal 6 relative to the atmosphere to resist the entry of air into the draw furnace 1. Preferably, the first seal 6 also physically and thermally isolates the chamber 4 so that the chamber 4 may be kept at or near an elevated operating temperature when the preform 3 is not present in the chamber 4. In a preferred embodiment the first seal 6 includes a mechanical shutter 7 that may be opened to receive the preform 3 during fiber draw, and closed when the preform 3 is mounted or removed from the draw furnace 1. Of course, any seal that adequately prevents air from entering the chamber 4 and isolates the heating area, without damaging the preform 3, is suitable and is considered to be within the scope of the present invention.

The preform 3 is lowered through the first seal 6 and into the chamber 4 at a predetermined rate during the fiber draw process. The chamber 4 is defined by a heating element 8 having two opposing openings. As shown in FIG. 2, a first opening 9 is disposed near to the first seal 6, and a second opening 10 opposes the first opening 9. In a preferred embodiment the heating element 8 couples with an applied magnetic field and generates heat inside the chamber 4. The portion of the preform 3 disposed in the chamber 4 is thereby heated to form the molten area from which the optical fiber 2 is drawn. The temperature of the molten area is preferably from 1700 to 2000 degrees Celsius. The invention is not limited to these preferred temperatures, and the preform 3 may be heated to any sufficient temperature outside the indicated range in order to create a molten area on the preform 3. In a preferred embodiment, the heating element 8 is primarily graphite, but other materials that couple with the applied magnetic field may also be used while remaining within the spirit of the invention. Other means of generating heat other than the applied magnetic field, such as a resistive furnace, may also be used to heat the preform 3.

Vapor products are present when the preform 3 is heated. The vapor products include, for example, silicon dioxide and silicon carbide and are at a temperature of approximately 1400 to 1800 degrees Celsius. Of course, additional vapor products such as other SiOₓ and SiCₓ may also be present during the draw process, and other temperatures are also considered to be within the scope of the present invention. The amount of vapor products corresponds to the equilibrium vapor pressure over the corresponding solid. Particles condense from the vapor products when the vapor products cool below the corresponding condensation temperature, and the optical fiber 2 is prone to break during the fiber draw process if the optical fiber 2 is contacted by the particles. To prevent the particles from contacting the optical fiber 2, the vapor products are exhausted from the chamber 4 before the particles are formed. Specifically, the heating element 8 includes a collar 12 located near the molten portion of the preform 3 and having a plurality of ports 13 disposed symmetrically around the circumference of the chamber 4 and through the wall of the heating element 8. Vapor products in the chamber 4 are exhausted through the ports 13 at a temperature above the vapor products' lowest condensation temperature. In a preferred embodiment the plurality of ports 13 are located between the first opening 9 and a melt region of the chamber 4 where the preform 3 becomes molten. A purge gas is introduced into the chamber 4 to assist in exhausting the vapor products. The purge gas is introduced through the second opening 10 of the chamber 4, flows through the chamber 4, and out the ports 13. In this manner the purge gas sweeps the vapor products away from the optical fiber 2 and out of the chamber 4 through the ports 13. The purge gas and vapor products exit through the ports 13 at a temperature of approximately 1200 to 1800 degrees Celsius. The temperature of the gasses is above the condensation temperature of the particles and the particles do not form within the chamber 4. In the preferred embodiment the purge gas is an inert gas such as argon and/or helium and is introduced at a rate of 2-10 liters per minute and a temperature of approximately to 100 to 1000 degrees Celsius. Of course, other gasses, flow rates and temperatures suitable for sweeping the vapor products through the ports 13 may also be used and are considered to be within the scope of the present invention. In alternative embodiments, the purge gas may be introduced into the chamber 4 from locations other than the second opening 10. For example, the purge gas may be introduced through a single port, or through multiple ports, disposed through the side of the chamber 4 at a location between the first opening 9 and the second opening 10. Additionally, the ports 13 for exhausting the gasses may be disposed asymmetrically around the circumference of the chamber 4, or one port 13 may be used instead of a plurality of ports 13 while remaining within the spirit of the present invention. Further, the ports 13 may be located at a position adjacent the region where the preform 3 is molten, or at a suitable location between the second opening 10 and the region where the preform 3 is molten, or other locations suitable for exhausting the gasses.

As shown in FIG. 2, passages 14 communicate with the ports 13 and facilitate exhausting the vapor products through the ports 13. The passages 14 are formed through a support structure 15. The support structure 15 provides mechanical support for the chamber 4 and includes one or more layers of a thermal insulation material for insulating the chamber 4 to prevent heat loss. In a preferred embodiment, the passages 14 pass through and are bounded by materials that couple with the applied magnetic field. For example, the passages 14 may be defined by structures incorporating graphite which couples with the applied magnetic field to generate heat. In this manner the gasses passing through the passages 14 do not fall below the condensation temperature of the constituent vapor products and particles do not condense in the passages 14. In a preferred embodiment the thermal insulation material may be graphite felt, rigidized graphite, or any thermal oxide insulation material. Of course, alternative thermal insulation may be used, and other configurations and materials may be used to define the passages 14 while remaining within the spirit of the invention. Additionally, the passages 14 may be defined by structures that do not generate heat if the particles are otherwise prevented from condensing in the passages 14.

As shown in FIG. 2, the passages 14 communicate with a gas inlet 16. The gas inlet 16 is configured to accept an inert gas supplied from a gas supply 17. The inert gas flows from the gas inlet 16, through the passages 14, and entrains the vapor products and purge gasses flowing through the passages 14. The combined gasses then flow to a second seal 18 and are exhausted from the draw furnace 1, as discussed below in more detail. The inert gas introduced through the gas inlet 16 may be, for example, argon and helium. Of course, other suitable gasses may also be used. The gas supply 17 may be a conventional gas supply 17 such as pressurized bottles, or other gas supplies may be used either concurrently with or instead of such bottles. The inert gas is preferably provided at a temperature of approximately 100 to 1000 degrees Celsius and at a flow rate of approximately 2-10 liters per minute, although other temperatures and flow rates are also possible.

In the preferred embodiment, the support structure 15 is surrounded by a globe 19. The globe 19 encloses the heating element 8 and the support structure 15, and other elements of the draw furnace 1, as illustrated in FIG. 2. The globe 19 helps maintain the inert gas atmosphere inside the draw furnace 1, acts as an additional layer of thermal and physical protection, and is constructed of a material that does not couple with the applied magnetic field. In the preferred embodiment, the globe 19 is constructed of quartz, either in whole or in part, or any other suitable insulating material.

Wrapped around the outer surface of the globe 19 is an induction coil 20. The induction coil 20 is connected to a power supply 21 that applies a magnetic field to the chamber 4. In the preferred embodiment, the induction coil 20 is a copper coil that carries an oscillating current supplied by the power supply 21. The induction coil 20 creates a perpendicular magnetic field that induces an oscillating current in the heating element 8, and any other structures that couple with the applied magnetic field, to generate heat. The power supply 21 may be any conventional power supply suitable for providing an oscillating current of sufficient magnitude to generate the above-discussed magnetic field. To protect the induction coil 20 and globe 19 from harm, a protective cover 22 is disposed around the exposed outer surfaces of the globe 19 and the induction coil 20. Alternatively, the draw furnace 1 may be constructed without the protective cover 22.

As previously mentioned, gasses flowing through the passages 14 are fed to the second seal 18. The second seal 18 includes second seal passages 23 communicating with the passages 14 and opening to the atmosphere. The gasses flowing through the passages 14 are thus exhausted from the draw furnace 1 after passing through the second seal 18. The second seal 18 is also configured to allow the drawn optical fiber 2 to exit the chamber 4 while preventing air from entering the chamber 4. Specifically, in the preferred embodiment the second seal 18 includes an extension tube 24 disposed generally co-axially with the chamber 4. The optical fiber 2 passes from the chamber 4 longitudinally through the extension tube 24 while an inert gas is fed through the extension tube 24. A portion of the inert gas flows in a direction opposing the direction of flow of the optical fiber 2 and passes through the second opening 10 of the chamber 4. More specifically, a gas injection port 25 for injecting the inert gas communicates with the extension tube 24. In the preferred embodiment, the gas injection port 25 has two 90-degree gas injectors that direct inert gasses into the extension tube 24 toward the second opening 10 of the chamber 4, and also into the extension tube 24 away from the second opening 10. The gas flowing toward the second opening 10 passes through the second opening 10 and into the chamber 4. This gas flows through the chamber 4 parallel to the optical fiber 2 and is the purge gas used to flush the vapor products from the chamber 4 in the manner previously discussed. The extension tube 24 and the inert gas insulate the optical fiber 2 from severe temperature gradients and allow controlled cooling of the optical fiber 2. The optical fiber 2 thus has relatively low residual stresses and correspondingly low attenuation characteristics. The inert gas is supplied by a gas supply 28 which may be any conventional gas supply.

The gas injection port 25 also directs the inert gas away from the second opening 10 and along the direction of travel of the optical fiber 2 as the optical fiber 2 exits the draw furnace 1. The inert gas flowing in the optical fiber 2's direction of travel prevents air from entering the draw furnace 1. In the preferred embodiment, a distal end 26 of the extension tube 24 terminates with an extension tube shutter 27. The extension tube shutter 27 can be opened to allow passage of the optical fiber 2 during the fiber draw process, and can be closed when the optical fiber 2 is not being drawn. Closing the extension tube shutter 27 maintains positive pressure of the inert gas within the draw furnace 1 and helps to prevent air from entering the draw furnace 1. In a preferred embodiment, the extension tube 24 may be made of quartz or any other suitable insulating material, and the inert gas may be supplied by any known gas supply 17.

Alternative embodiments of the second seal 18 are considered to be within the scope of the present invention. The inert gas may be introduced into the second seal 18 at a location other than through the extension tube 24. As previously discussed, the inert gas may be introduced directly into the chamber rather than into the second seal 18, and the portion of the inert gas that does not sweep through the ports 13 may flow into the second seal 18 from the chamber 4. Further, exhausting the gasses flowing through the second seal passages 23 may be assisted by a fan or pump, a gas entraining the gasses from the passages 14, or any other pressure differential to draw or force the gasses through the second seal passages 23. The gasses may be vented to the atmosphere or may be cooled or treated to remove constituent gasses.

As discussed above in detail, the heating element 8, and other elements, couple with the applied magnetic field generated by the induction coil 20 to generate heat. The heat melts a lower portion of the preform 3, and the optical fiber 2 is drawn from the melted area and passes out of the chamber 4. Vapor products are generated during the draw process and these gasses are flushed from the chamber 4 by the purging gas. The gasses exit the chamber 4 by passing through the ports 13, passages 14, and second seal 18 and out of the draw furnace 1 at a sufficiently high temperature to prevent particles from condensing from the gasses. In this manner the particles do not condense from the vapor products until the vapor products exit the draw furnace 1. The particles thus condense away from the optical fiber 2, and the optical fiber 2 is protected from unwanted breakage. Further, as shown in FIG. 1, the optical fiber 2 exits the extension tube 24 and passes through the fiber coating device 5 (FIG. 1). In the fiber coating device 5, the optical fiber 2 is coated with one or more layers of coatings having predetermined physical and optical properties. The coatings protect the surface of the optical fiber 2 from scratches, abrasions and moisture. The coating device may include one or more curing stages for curing the coating, and one or more cooling stages for cooling the optical fiber 2 and/or the coating. Subsequent to being coated, the optical fiber 2 is wound on a spool for storage.

Although specific embodiments of the present invention have been described above in detail, it will be understood that this description is merely for illustration purposes. Various modifications of and equivalent structure corresponding to the disclosed aspects of the preferred embodiments in addition to those described above may be made by those skilled in the art without departing from the present invention which is defined in the following claims. The scope of the claims is to be accorded the broadest interpretation so as to encompass such modifications and equivalent structures.

What is claimed is:

1. A furnace, comprising:
a chamber for heating a portion of a preform to draw a fiber, said chamber having a melt region for melting the preform, and at least one port disposed proximate to the melt region; and
a purge gas supply for supplying a purge gas into said chamber, the purge gas moving vapor products away from the fiber and exiting said chamber through said at least one port.

2. A furnace as recited in claim 1, wherein said chamber includes a preform opening through which the preform passes, and said at least one port is disposed between the preform opening and the melt region.

3. A furnace as recited in claim 2, wherein the vapor products exit said chamber before particles form from the vapor products.

4. A furnace as recited in claim 2, wherein the vapor products exit said chamber at a temperature above a condensation temperature.

5. A furnace as recited in claim 1, wherein said at least one port is disposed relative to said chamber such that the vapor products are exhausted through said at least one port before particles form.

6. A furnace as recited in claim 1, wherein said at least one port is positioned relative to said chamber such that the vapor products are exhausted at a temperature of at least 1200 degrees Celsius.

7. A furnace as recited in claim 1, further comprising a supporting structure having passages communicating with said at least one port for carrying the vapor products and the purge gas away from said chamber.

8. A furnace as recited in claim 1, wherein said purge gas supply introduces the purge gas into said chamber in a direction generally parallel to the fiber.

9. A furnace as recited in claim 1, further comprising heating means for heating the preform.

10. A furnace as recited in claim 1, further comprising a fiber coating device.

11. A fiber forming device, comprising:
heat generating means for melting a portion of a preform;
gas supply means for supplying a purge gas for purging vapor products from said heat generating means; and
exhausting means for exhausting the purge gas and the vapor products out of said heat generating means before particles condense from the vapor products.

12. A fiber forming device as recited in claim 11, wherein said exhausting means includes at least one port disposed proximate to a melting portion of the preform.

13. A fiber forming device as recited in claim 11, wherein said exhausting means and said heat generating means are configured to exhaust the vapor products and the purge gas at a temperature of at least 1200 degrees Celsius.

14. A fiber forming device as recited in claim 11, wherein said heat generating means includes a preform opening through which the preform passes and a melt region where the preform is melted, and said exhausting means includes at least one port disposed at a location between the preform opening and the melt region.

15. A fiber forming device as recited in claim 11, further comprising fiber coating means for coating a fiber.

16. A method of drawing fiber comprising the steps of:
providing a chamber having a preform opening for accepting a preform, and a melt region for melting the preform;
heating the preform in the melt region of the chamber until a portion of the preform is molten and vapor products are present; and
exhausting the vapor products from the chamber before particles condense from the vapor products.

17. A method of drawing fiber as recited in claim 16, further comprising the step of exhausting the vapor products at a temperature above a condensation temperature.

18. A method of drawing fiber as recited in claim 16, further comprising the step of exhausting the vapor products from the chamber at a location between the preform opening and the melt region.

19. A method of drawing fiber as recited in claim 16, further comprising the step of drawing a fiber from the preform.

20. A method of drawing fiber as recited in claim 19, further comprising the step of coating the fiber with a predetermined material.
